(19) United States
(12) Patent Application Publication
(10) Pub. No.: US 2026/0340286 A1
(43) Pub. Date: Oct. 29, 2026

(54) SAFETY ENGINE PROCESSING OF GENERATIVE RESPONSE ENGINE OUTPUT

(71) Applicant: OpenAI OpCo, LLC., San Francisco, CA (US)

(72) Inventors: Madelaine Boyd, San Francisco, CA (US); Justyn Harriman, San Francisco, CA (US); Tomer Kaftan, San Francisco, CA (US); Brendan Quinn, San Francisco, CA (US); Filippo Raso, San Francisco, CA (US); Samuel Toizer, Oakland, CA (US); Haoyu Wang, San Francisco, CA (US); Mehmet Yatbaz, San Francisco, CA (US); Jieqi Yu, San Francisco, CA (US)

(73) Assignee: OpenAI OpCo, LLC., San Francisco, CA (US)

(21) Appl. No.: 19/189,837

(22) Filed: Apr. 25, 2025

(51) Int. Cl. G06F 40/284

(52) U.S. Cl. CPC G06F 40/284

(57) ABSTRACT

The present technology pertains to optimizing the performance and safety of generative response engines used to produce multi-modal outputs, including audio, text, and visual media. The present technology introduces guardrails and safety checks without degrading user experience through perceptible lag, particularly in conversational or speech modes. The technology employs tunable processing to ensure compliance with safety guidelines while maintaining real-time output. It utilizes a main queue to index output tokens, feeding them into both a safety queue and an output queue. The system allows simultaneous token processing; the safety engine performs checks while a tunable buffer enables a limited number of tokens to bypass immediate safety verification to maintain conversational flow.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2 illustrates an example system for implementing safety checks on generative response engine output in accordance with some aspects of the present technology.

FIG. 3 illustrates an example system for processing of a stream of tokens in accordance with some aspects of the present technology.

FIGS. 4A and 4B illustrate an example of processing of a stream of tokens in accordance with some aspects of the present technology.

FIG. 5 illustrates an example method for processing a stream of tokens output by a generative response engine in accordance with some aspects of the present technology.

FIG. 6 is a block diagram illustrating an example machine-learning platform for implementing various aspects of this disclosure in accordance with some aspects of the present technology.

FIGS. 7A, 7B and 7C illustrate an example transformer architecture in accordance with some aspects of the present technology.

FIG. 8 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

While generative response engines represent a powerful tool for generating multi-modal outputs, such as audio, text, visual media, there is potential for misuse - either accidental or malicious. Accordingly, guardrails and safety checks can be used to ensure that output of a generative response engine conforms with regulatory and ethical guidelines. However, implementation of guardrails and safety checks can hinder user experience, for example, by introducing lag in delivering a response to a user. Lag can be particularly detrimental to the user experience when the user is interacting with a generative response engine in a conversational or speech mode. Time taken to perform safety checks on the backend can create unnatural or extended pauses in the responses of the generative response engine, thereby interrupting the natural conversational flow of the prompts and responses.

The present technology aims to address these and other challenges associated with ensuring output of a generative response engine conforms to safety requirements without introducing perceptible lag in the delivery of responses to the user. To achieve these improvements, systems and methods include processing of generative response engine output by a safety engine, where the processing is tunable to be synchronous or asynchronous. For example, tokens output by the generative response engine can be indexed and provided to a main queue. The main queue can be used to feed a safety queue and an output queue. The safety queue can provide output tokens to a safety engine configured to perform one or more safety checks on the output tokens. Simultaneously, the output queue can provide output tokens to a front end to the generative response engine while the difference in the index of the token being provided to the front end and the token being provided to the safety engine is less than a buffer amount. The buffer can be adjusted based on performance requirements and can allow a certain number of unchecked tokens to be output to the front end before pausing the output of tokens to the front end to allow the safety engine to catch up.

Accordingly, aspects of the present technology can prevent prohibited output of tokens while balancing the need for real-time or near-real-time output of tokens to a user. Disclosed systems and methods can, for example, ensure that a generative response engine is prevented from providing prohibited or restricted output beyond an amount of output tokens allowed to be provided without being checked by the safety engine. The tunable or customizable buffer can be adjusted to balance performance with output safety, thereby maintaining the user experience.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

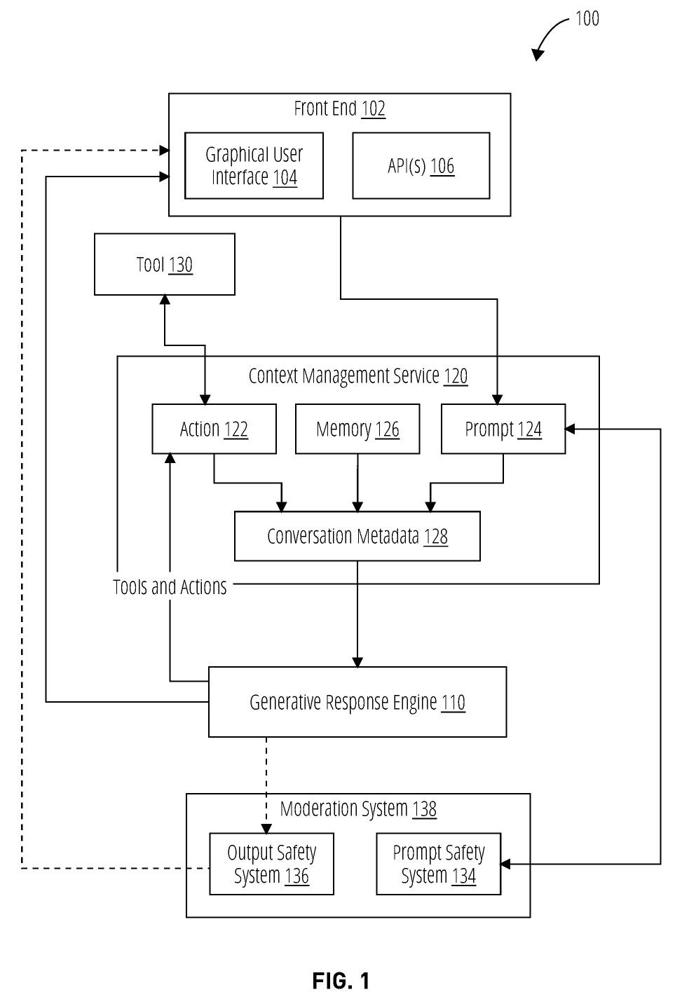

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI’s persona, style, and constraints. There can be levels of system prompts. A highest level of a system prompt might be provided by the generative response engine 110 provider and is meant to establish policies for the behavior of generative response engine 110. This highest level of system prompt should be prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine’s capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation. Generally, prompt 124 will include an entire conversation thread, but in some instances, prompt 124 might need to be shortened if it exceeds a maximum accepted length (generally measured by a number of tokens).

Context management service 120 can also route prompts and response through moderation system 138. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at...), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some aspects, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of context management service 120.

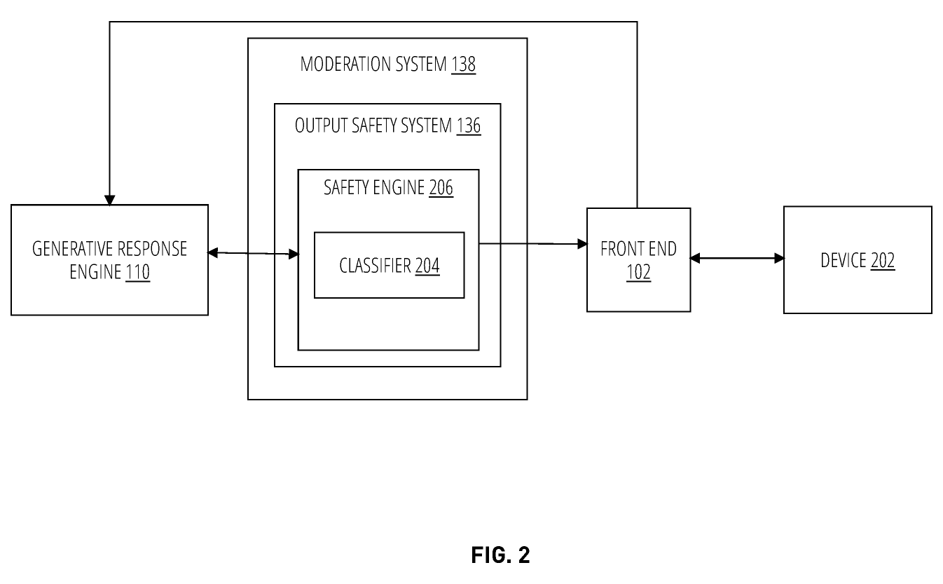

FIG. 2 illustrates an example system for performing one or more safety checks on output from a generative response engine. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

In FIG. 2, generative response engine 110 may output audio content in response to a prompt received via front end 102 from a user account. Generative response engine 110 may output audio content as a stream of tokens. Before providing the audio content to front end 102 for being output to device 202, generative response engine 110 can stream tokens to safety engine 206 of output safety system 136 as the tokens are output by generative response engine 110.

Safety engine 206 can be configured to analyze the output tokens to determine whether the output audio content should be provided to device 202 as output. For example, safety engine 206 can be used to determine whether the output audio content contains a voice that deviates from a voice derived from an allowed voice samples and/or whether the output audio content contains music.

Safety engine 206 can include a classifier 204. Classifier 204 can be configured to receive audio output and classify whether audio output contains a voice that deviates from a voice generated using an allowed voice sample. In one example, classifier 204 may include an ML model that is trained to identify and quantify deviations of a voice in an audio sample (e.g., the audio output) from a reference voice (e.g., a voice generated by generative response engine 110 from a voice sample). The ML model trained for this task can be a small ML model having fewer parameters and layers than the generative response engine and is configured for a single classification task. Classifier 204 can be configured to output a deviation score, where the deviation score indicates an amount of deviation of a voice in the audio output from a reference voice.

Classifier 204 can output a deviation score for respective windows of the audio output. The windows of audio output can be of predetermined length and can be at least partially overlapping. For example, a first audio window can partially overlap with a second audio window, and the second audio window can overlap with a third audio window. Classifier 204 can output a deviation score for each successive audio window as the audio output is received from generative response engine 110. Safety engine 206 can compare the score with a deviation score threshold to determine whether the audio output can be provided to front end 102 for output to device 202. For example, safety engine 206 can determine not to output the audio output if the respective deviation scores in two sequential audio windows are greater than the deviation score threshold.

If the deviation scores determined based on two sequential windows of audio output are greater than the deviation score threshold, safety engine 206 can provide a message to generative response engine 110 to cause generative response engine 110 to cease output of further audio. Simultaneously or in tandem, safety engine 206 can provide, to front end 102, a message to be provided to the user account via device 202 indicating that generative response engine 110 is unable to provide a response to the prompt.

If the deviation score in a particular audio window is less than the deviation score threshold (e.g., the voice in the audio output of the particular audio window does not deviate from the reference voice beyond an allowed amount), safety engine 206 can provide the audio output to front end 102, which, in turn, streams the audio output to device 202. Similarly, if the deviation score in the particular audio window is greater than the deviation score threshold, but the deviation score for an audio window immediately following or preceding the particular audio window is less than the deviation score threshold, the audio output in the particular audio window can be provided to front end 102 for output to device 202.

In another example, classifier 204 can be configured to receive audio output and classify whether the audio output contains music. In one example, classifier 204 may include an ML model that is trained to identify whether an audio sample contains music. For example, the ML model can be trained to identify when an audio sample contains one or more parameters indicative of music, such as a rhyme scheme (e.g., indicative of lyrics), variations in pitch and tone, and/or percussive beats. The ML model trained for this task can be a small ML model having fewer parameters and layers based on a single classification task. Classifier 204 can be configured to output a music score, where the music score indicates a likelihood that the audio output contains music. In some examples, the music score classifier and the deviation score classifier can be the same model (e.g., classifier 204). In other examples, the music score classifier and the deviation score classifier are different models.

Classifier 204 can output a music score for respective windows of the audio output. Classifier 204 can output the music score for each successive audio window as the audio output is received from generative response engine 110. Safety engine 206 can compare the music score with a music score threshold to determine whether the audio output can be provided to front end 102 for output to device 202. For example, safety engine 206 can determine not to output the audio output if the respective music scores in two sequential audio windows are greater than the music score threshold (e.g., indicating that audio output of both audio windows contains music).

If the music scores determined based on two sequential windows of audio output are greater than the music score threshold, safety engine 206 can provide a message to generative response engine 110 to cause generative response engine 110 to cease output of further audio. Simultaneously or in tandem, safety engine 206 can provide, to front end 102, a message to be provided to the user account via device 202 indicating that generative response engine 110 is unable to provide a response to the prompt.

If the music score in a particular audio window is less than the music score threshold (e.g., no music was detected in the audio output of the particular audio window), safety engine 206 can provide the audio output to front end 102, which, in turn, streams the audio output to device 202. Similarly, if the music score in the particular audio window is greater than the music score threshold, but the music score for an audio window immediately following or preceding the particular audio window is less than the music score threshold, the audio output in the particular audio window can be provided to front end 102 for output to device 202.

In some examples, the determination of whether to output the audio to front end 102 can be based on a single audio frame for both voice deviation and music detection or for either voice deviation or music detection. Further, the sensitivity of safety engine 206 can be tuned by varying the deviation score threshold and/or music score threshold. For example, by increasing the deviation score threshold, the deviation score required to prevent audio output will need to be higher to stop the output, meaning the system will allow a greater amount of deviation from the reference voice. In another example, decreasing the music score threshold may cause prevention of a greater amount of audio output because more audio samples will be classified as containing music.

The example system illustrated in FIG. 2 can be used to evaluate generative response engine output, for example, to determine whether it complies with one or more guidelines, or can be used to log output of a generative response engine for auditing. Safety engine 206 can include several classifiers, including classifier 204, configured to determine, at least in part, whether output of generative response engine 110 comports with required guidelines and therefore whether the output can be provided to a user account. However, depending on the number of safety checks and on respective safety checks' computational requirements, checking tokens output by generative response engine 110 can introduce lag or delays in providing the output to the user account. This can be particularly detrimental to the user experience when a user is interacting with the generative response engine in a voice or conversational mode as it hinders the natural, real-time flow of the conversation.

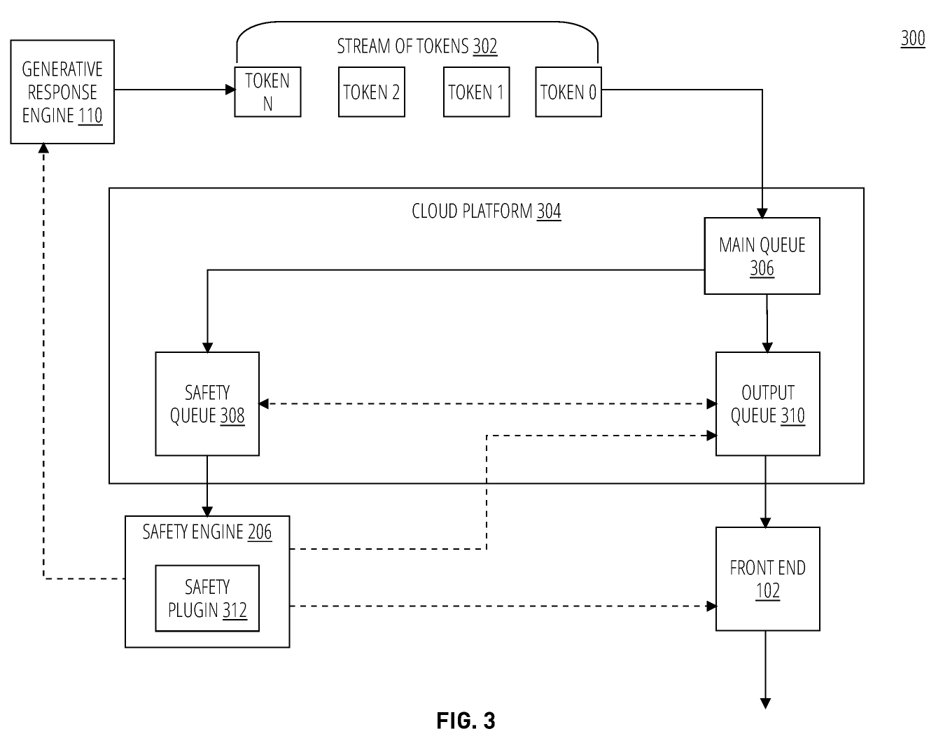

To address the need to balance safety and performance, or user experience, the present technology implements processing of tokens output by the generative response engine, as will be described below with reference to FIGS. 3, 4A, 4B and 5. In the examples described below, a tunable buffer can be used to allow a defined number of unchecked tokens to be provided to the user account as safety checks are performed on the output tokens. Accordingly, output of the generative response engine can be checked for compliance with one or more guidelines or requirements without introducing perceptible lag into the output received by the user account.

FIG. 3 illustrates an example system 300 for processing output from a generative response engine in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 300 can be used, for example, to asynchronously or synchronously perform one or more safety checks on output from generative response engine 110. Generative response engine 110 can output a stream of tokens 302 in response to a prompt received from a user account. System 300 facilitates performance of safety checks on stream of tokens 302 to avoid providing prohibited or restricted output to the user account. Generative response engine 110 may generate prohibited output based on a prompt, which can either accidentally or maliciously result in output that violates one or more safety guardrails or policies.

System 300 can include a cloud platform 304 configured to host and manage queues (e.g., a main queue 306, a safety queue 308, and an output queue 310). Main queue 306 can receive a stream of output tokens from generative response engine 110, where respective tokens of the stream of output tokens are assigned an index. Main queue 306 can feed safety queue 308 and output queue 310 with the stream of tokens. For example, main queue 306 may feed duplicate streams of tokens (e.g., duplicates of stream of tokens 302) to safety queue 308 and output queue 310.

Safety queue 308 can provide tokens to safety engine 206. Safety engine 206 can include safety plugin 312, which may be configured to check output tokens to ensure compliance with system guidelines and may be associated with a buffer. For example, safety plugin 312 can check generative response engine 110 output for particular content types (e.g., music) or for particular content (e.g., prohibited or sensitive content) that should not be output to the user account in response to a prompt. In some examples, safety engine 206 can include more than one safety plugin 312, where each safety plugin is configured to check output token compliance with a guideline or requirement and is associated with a buffer.

Safety plugin 312 can be configured to evaluate output tokens for compliance with a particular guideline or guardrail. In some examples, safety plugin 312 can include a classifier configured to receive output tokens and output a determination of whether the output tokens adhere to a particular guideline. In another example, a classifier (e.g., classifier 204) can output a score based on the tokens, such that the score can be compared with a threshold to determine whether the tokens are compliant with a guideline. The classifier may include an ML model that is trained to identify tokens that are not compliant with one or more guidelines. The ML model trained for this task can be a small ML model having fewer parameters and layers than the generative response engine and is configured for a single classification task.

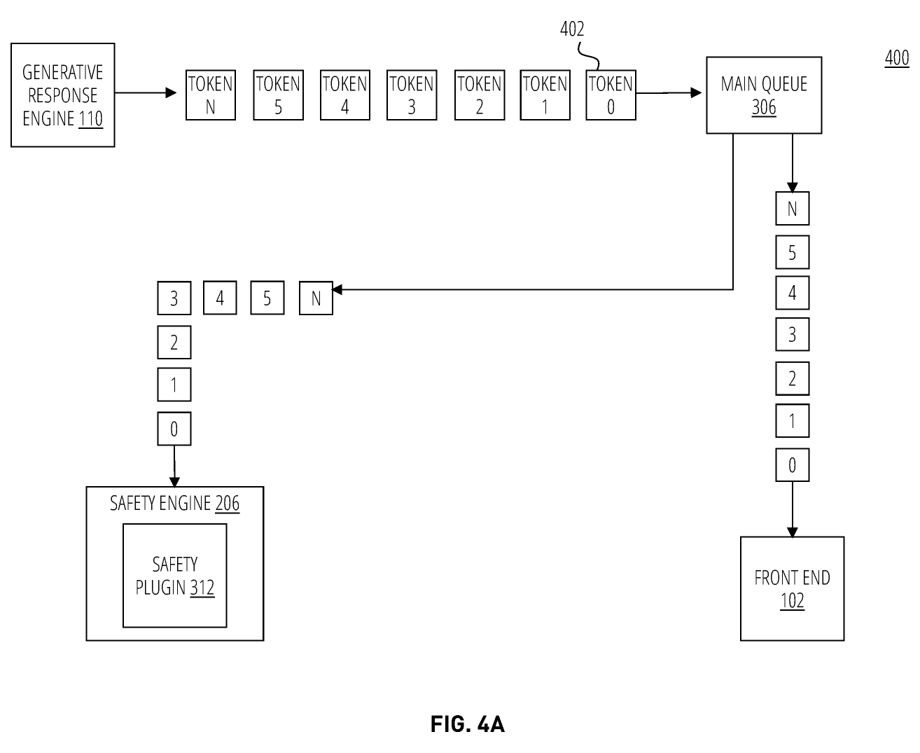

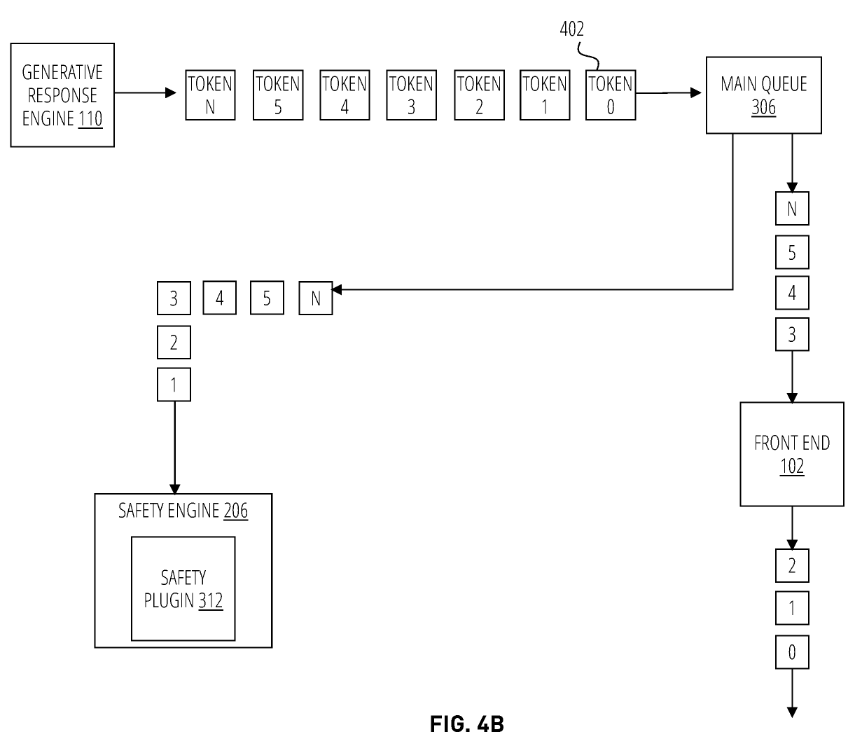

While safety engine 206 is consuming and evaluating tokens from safety queue 308, front end 102 can consume tokens from output queue 310, which it can, in turn, provide as output to the user account so long as a difference between the index of a token being consumed by front end 102 from output queue 310 and the index of a token being evaluated by safety plugin 312 is less than a buffer. The buffer represents a number of tokens that can be provided to the user account by front end 102 before requiring the output queue 310 to pause for safety plugin 312 to catch up in evaluating tokens. An example is described below with reference to FIGS. 4A and 4B.

In some examples, one or more components of cloud platform 304 can manage safety queue 308 and output queue 310 to ensure that the difference between the index of a token fed into front end 102 by output queue 310 and the index of a token fed into safety plugin 312 by safety queue 308 is less than the buffer. If safety engine 206 determines that the difference is greater than or equal to the buffer for safety plugin 312, safety engine 206 can communicate to output queue 310 and/or front end 102 such that output queue 310 pauses the providing of tokens to front end 102 as safety plugin 312 processes tokens from safety queue 308 until the difference is less than the buffer. Thus, output by front end 102 to the user account is only paused when the output gets farther ahead of the safety plugin 312 than is allowed by the buffer for the particular plugin.

In some examples, front end 102 may communicate with safety engine 206, by providing to safety engine 206 an index of a token about to be output by front end 102. Safety engine 206 can include logic to determine if the token having the index from front end 102 has been approved for output to the user account and, if the token having that index has not been checked by safety engine 206, to determine whether the difference between the index of the token from front end 102 and the index of the most recently checked token by the safety plugin 312 is less than the buffer. If the token having the index has been checked by safety plugin 312 or if the difference in indexes is less than the buffer, safety engine 206 can communicate to front end 102 that it may output to the user account the token having the index.

In some examples, if the difference in indexes is greater than or equal to the buffer, safety engine 206 may communicate to output queue 310 and/or front end 102 to stop outputting tokens until the difference between the index of the token from front end 102 and the most recent token checked by the safety plugin 312 is less than the buffer. In some cases, to prevent undue lag or in case of error, front end 102 may pause output of tokens until the expiration of a timeout period. If front end 102 has not output tokens for a period time (e.g., because the difference in indexes has remained greater than or equal to the buffer), once the period of time exceeds the timeout period, front end 102 can continue to consume and output tokens from output queue 310. As another method of failure protection, safety plugin 312 may be configured such that it may be switched on or off by a system administrator. Accordingly, if safety engine 206 includes more than one safety plugin, each plugin may be capable of being switched off individually or all safety plugins can be switched off. This can allow tokens to flow to the user account in the event of an error with one or more plugins of safety engine 206.

If one or more tokens do not pass safety checks of safety plugin 312, safety engine 206 can insert a stop token in output queue 310, such that once front end 102 consumes the stop token from output queue 310, front end 102 ceases output of tokens after the stop token. In some examples, the stop token can cause output queue 310 from outputting further tokens and the stop token may include metadata such that when the stop token is consumed by front end 102, front end 102 outputs a message to the user account indicating that further output cannot be provided. In some examples, safety engine 206 can communicate directly with front end 102 to stop output of further tokens. Additionally, if one or more tokens do not successfully pass safety checks of safety plugin 312, safety engine 206 can transmit, to generative response engine 110 a special token configured to cause generative response engine 110 to cease outputting tokens in response to the prompt, or can transmit a message to generative response engine 110 configured to cause generative response engine 110 to cease outputting tokens in response to the prompt.

In some examples, safety engine 206 can include a number of safety plugins 312, where different plugins check token conformity with different guidelines or rules and where each safety plugin is associated with a buffer. In some examples, whether or not a token or set of tokens is considered “safe” to output, per safety engine 206, can depend on the token or set of tokens being approved for output by all safety plugins of safety engine 206 or by a subset of particular safety plugins of safety engine 206.

In one non-limiting example, a safety plugin may include a classifier trained to output a score indicating a deviation of a voice in audio output of generative response engine 110 from a reference voice. In this example, the safety plugin may analyze overlapping windows of tokens to receive a score for each window. Based on the scores, the safety plugin can determine whether to output tokens of one or both windows (e.g., if, based on the scores, the audio in two consecutive windows does not deviate from a reference voice by greater than an allowed amount). Further, in some examples, a safety plugin may use a classifier to evaluate overlapping windows of the stream of tokens (e.g., overlapping subsets of tokens).

In another example, a safety plugin can check the output stream of tokens for prohibited material (e.g., copyright-protected content). In this example, the safety plugin may reference a database of copyrighted material to determine if there is a match in the database with the output tokens or a set of output tokens. Based on a positive match, the safety plugin may determine that a respective token or respective tokens is or are not approved for output to a user account. The examples of safety plugins described herein are meant to be non-limiting. Safety engine 206 can include any number of safety plugins using any methods for determining whether or not to output a token or set of tokens.

In some examples, safety engine 206 can include two or more safety plugins, where respective safety plugins are associated with a respective buffer. The buffer for a safety plugin defines a number of tokens that may be output to a user account for a token checked and approved by the respective plugin. In some examples, a safety plugin may be associated with a buffer of zero, meaning that a token has to be checked and approved for output by the safety plugin before it is output to a user account. This scenario can also be referred to as synchronous processing, as no tokens are allowed to be output by front end 102 without being approved (or deemed “safe” to output) by the respective plugin. In some examples, the buffer for a respective plugin can be set to a relatively high number, such that a large number of unchecked tokens are allowed to be output by front end 102. The buffer for a respective safety plugin may be customizable or tunable. For example, a system administrator may modify the buffer of the respective safety plugin. Accordingly, the present technology provides the flexibility to tune the synchronicity or asynchronicity of each plugin of safety engine 206.

FIG. 4A illustrates an example of a process 400 for processing tokens output by generative response engine 110 in accordance with aspects of the present disclosure.

In response to a prompt from a user device, generative response engine 110 can output a stream of tokens (e.g., tokens indexed 0 through N). As tokens in the stream of tokens are output by generative response engine 110, they can be added to main queue 306. In some examples, main queue 306 can be a queue hosted on and managed by cloud platform 304.

Main queue 306 can pass duplicates of the stream of tokens to safety queue 308 and output queue 310. In some examples, cloud platform 304 may include one or more cloud services configured to duplicate tokens as they are fed from main queue 306 to safety queue 308 and to output queue 310.

As discussed above, safety queue 308 may feed tokens to safety engine 206. Safety engine 206 can consume the tokens from safety queue 308 to sequentially check tokens or sets of tokens, using safety plugin 312, for compliance with one or more guidelines or rules. Simultaneously, output queue 310 can feed tokens to front end 102. Front end 102 can, in turn, output tokens received from output queue 310 to a user account, thereby providing the response from generative response engine 110 to the user account.

FIG. 4B illustrates a continuation of example process 400, in accordance with aspects of the present disclosure, and illustrates the processing of tokens by safety plugin 312 of safety engine 206.

As discussed above, safety engine 206 may consume tokens from safety queue 308 while front end 102 consumes tokens from output queue 310. Because of the time required to process tokens using safety plugin 312, front end 102 may output tokens to the user account faster than safety plugin 312 is able to check tokens for compliance with safety guidelines. The bounded asynchronous processing of tokens from main queue 306 can facilitate balancing the need to check tokens for safety guideline compliance without introducing lag that hinders the user experience. In some examples, whether the processing of tokens from main queue 306 is synchronous or asynchronous can be tuned by adjusting the buffer of safety plugin 312.

For example, a tunable buffer can define an amount of unchecked tokens (e.g., unchecked by safety plugin 312) are allowed to be output to the user account by front end 102 before output of tokens by front end 102 needs to be paused to allow safety plugin 312 to catch up. In this example, let the buffer be three tokens. At the instant of time illustrated in FIG. 4B, front end 102 has output Tokens 0 through 2 to the user account, such that front end 102 is about to consume Token 3 from output queue 310. At this time, safety plugin 312 may have checked Token 0 and is about to consume Token 1 to perform safety checks on Token 1.

Because the buffer is three tokens, three tokens in advance of the token about to be consumed by safety plugin 312 from safety queue 308 may be consumed by front end 102 from output queue 310. Assuming Token 0 has been deemed “safe” by safety plugin 312, front end 102 may consume and output to a user account, Tokens 1, 2, and 3 while Token 1 is being evaluated by safety plugin 312. Thus, the index of the most recent token output by output queue 310 (3) minus the index of the token being consumed from safety queue 308 (1) is two, which is less than the buffer of three tokens.

In a more detailed example, front end 102 may communicate to safety engine 206 that it has received or is about to receive Token 3 from output queue 310. Safety engine 206 can determine that Token 3 has not been checked by safety plugin 312. Safety engine 206 can further compare the index of Token 1 (e.g., the next token to be checked) with the index received from front end 102 (e.g., 3). The difference in indexes of these tokens is two, which is less than the buffer, so front end 102 may proceed with outputting Token 3 to the user account.

However, front end 102 may be blocked from consuming Token 4 from output queue 310 while safety plugin 312 is processing Token 1 (e.g., output from output queue 310 and/or front end 102 may be paused by safety engine 206), because the difference in the index of the most recent token consumed by front end 102 from output queue 310 and the index of the token being evaluated by safety plugin 312, or about to be evaluated by safety plugin 312, is three, which is greater than or equal to the buffer amount. Once safety plugin 312 deems Token 1 as being “safe,” safety engine 206 may communicated with output queue 310 to cause output queue 310 resume output of tokens. In some examples, safety engine 206 may communicate with front end 102 to cause front end 102 to continue consuming and outputting tokens from output queue 310.

In some examples, the buffer amount can be tuned based on a desired balance between safety and user experience. Testing or simulations can be used to determine a buffer that does not introduce perceptible lag or, for example, that requires a certain percentage of tokens to be deemed “safe” per output of unchecked tokens.

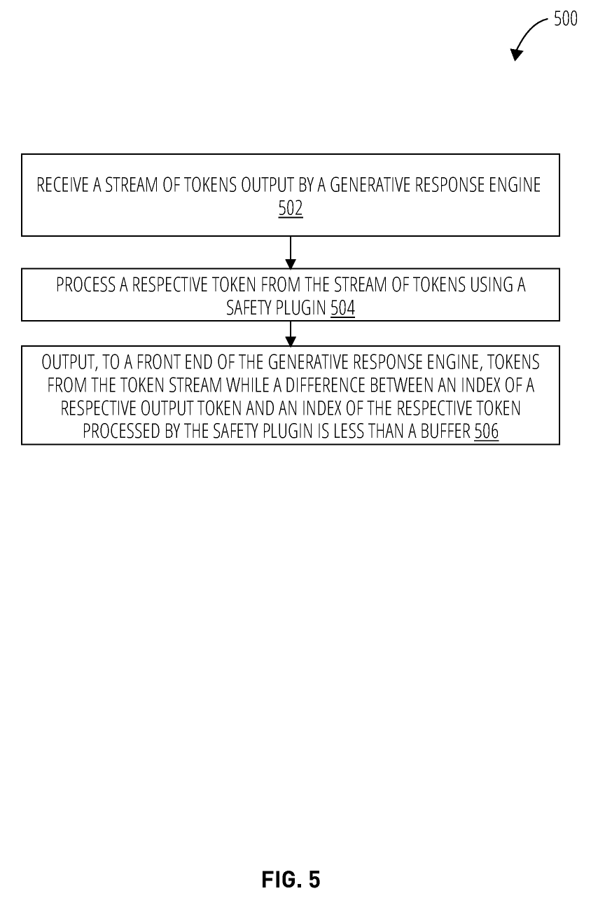

FIG. 5 illustrates an example method 500 for processing of tokens output by a generative response engine. Although example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements method 500 may perform functions at substantially the same time or in a specific sequence.

In block 502, method 500 includes receiving, at a safety engine, a stream of tokens output by a generative response engine. For example, safety engine 206 can receive a stream of tokens (e.g., stream of tokens 302) from generative response engine 110. The stream of tokens may be output by generative response engine 110 in response to a prompt received at generative response engine 110 via front end 102 from a user account. Respective tokens in the stream of tokens may be assigned an index. For example, cloud platform 304 may manage a main queue 306, which is fed tokens from generative response engine 110 as they are output.

Main queue 306 may feed duplicate streams of tokens to safety queue 308 and output queue 310. These three queues (main queue 306, safety queue 308, and output queue 310) may be hosted on and managed by cloud platform 304. For example, cloud platform 304 may include one or more cloud services configured to manage main queue 306, safety queue 308, and output queue 310.

In block 504, method 500 may include processing, by the safety engine, a respective token from the stream of tokens using a safety plugin. For example, main queue 306 can supply tokens to safety queue 308 such that safety engine 206 can consume tokens from safety queue 308 for processing by safety plugin 312. Simultaneously, front end 102 may consume tokens from output queue 310 and provide the consumed tokens sequentially to the user account.

Safety plugin 312 can process respective tokens as they are consumed at safety engine 206 to determine whether the respective token can be deemed “safe” and can therefore be output to the user account. For example, safety plugin 312 can use a classifier to output a decision or prediction of whether the respective token is “safe” (e.g., whether the output token adheres to one or more safety guidelines. In some examples, if safety plugin 312 determines a token is not “safe,” to output to the user account, safety engine 206 can communicate with generative response engine 110, output queue 310, and/or front end 102 to prevent further output of tokens from output queue 310 to front end 102 and/or the user account. In some examples, a stop token inserted by safety engine 206 into output queue 310 may include metadata used by front end 102 to cause front end 102 to provide a message to user account indicating that further output cannot be provided. While tokens are being determined to be safe by safety engine 206, front end 102 can continue consuming and outputting tokens from output queue 310, so long as the buffer condition described below is met as determined by safety engine 206.

In block 506, method 500 can include outputting, to a front end of the generative response engine, tokens from the token stream while a difference between an index of a respective output token and an index of the respective token processed by the safety engine is less than a buffer. For example, front end 102 can consume tokens from output queue 310 fed by main queue 306. The buffer may define a number of unchecked (e.g., unchecked by safety plugin 312) tokens that may be output, before pausing output queue 310 until safety queue 308 catches up. For example, front end 102 can continue consuming tokens from output queue 310 so long as the difference in the index of the most recently consumed token and the index of the most recently consumed token from safety plugin 312 is less than the buffer. If this difference is greater than or equal to the buffer, a queue management service of cloud platform 304 may pause output of tokens from output queue 310 until the difference decreases to less than the buffer. In another example, if the difference is greater than or equal to the buffer, safety engine 206 may communicate with output queue 310 and/or front end 102 to cause output queue 310 or front end 102 to pause output of the stream of tokens.

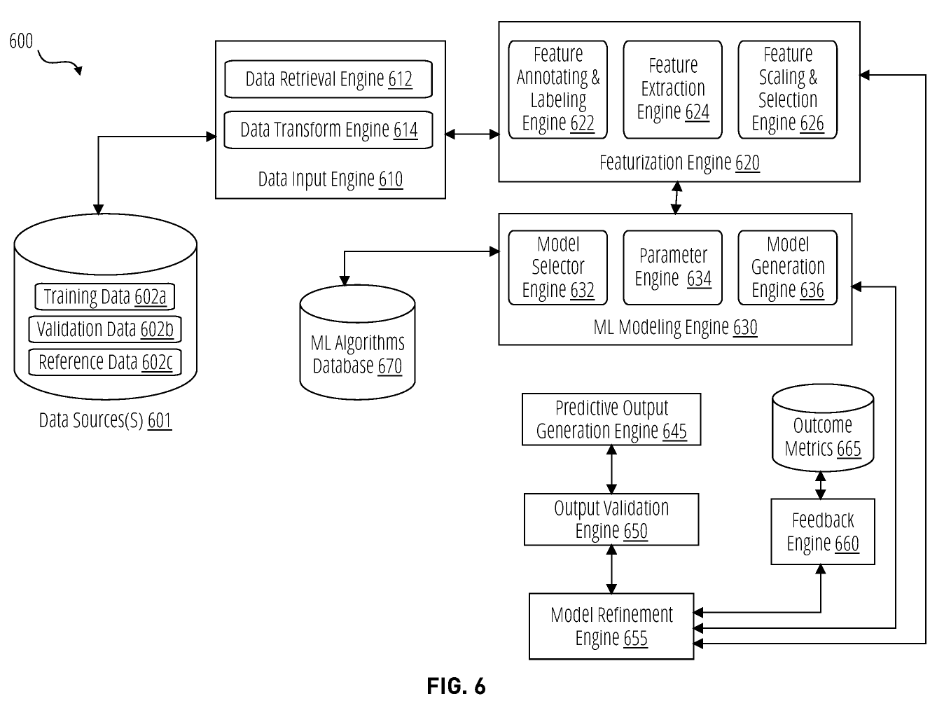

FIG. 6 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 600 may include data input engine 610 that can further include data retrieval engine 612 and data transform engine 614. Data retrieval engine 612 may be configured to access, interpret, request, or receive data, which may be adjusted, reformatted, or changed (e.g., to be interpretable by another engine, such as data input engine 610). For example, data retrieval engine 612 may request data from a remote source using an API. Data input engine 610 may be configured to access, interpret, request, format, re-format, or receive input data from data sources(s) 601. For example, data input engine 610 may be configured to use data transform engine 614 to execute a re-configuration or other change to data, such as a data dimension reduction. In some aspects, data sources(s) 601 may be associated with a single entity (e.g., organization) or with multiple entities. Data sources(s) 601 may include one or more of training data 602a (e.g., input data to feed a machine learning model as part of one or more training processes), validation data 602b (e.g., data against which at least one processor may compare model output with, such as to determine model output quality), and/or reference data 602c. In some aspects, data input engine 610 can be implemented using at least one computing device. For example, data from data sources(s) 601 can be obtained through one or more I/O devices and/or network interfaces. Further, the data may be stored (e.g., during execution of one or more operations) in a suitable storage or system memory. Data input engine 610 may also be configured to interact with a data storage, which may be implemented on a computing device that stores data in storage or system memory.

System 600 may include featurization engine 620. Featurization engine 620 may include feature annotating & labeling engine 622 (e.g., configured to annotate or label features from a model or data, which may be extracted by feature extraction engine 624), feature extraction engine 624 (e.g., configured to extract one or more features from a model or data), and/or feature scaling & selection engine 626 Feature scaling & selection engine 626 may be configured to determine, select, limit, constrain, concatenate, or define features (e.g., AI features) for use with AI models.

System 600 may also include machine learning (ML) ML modeling engine 630, which may be configured to execute one or more operations on a machine learning model (e.g., model training, model re-configuration, model validation, model testing), such as those described in the processes described herein. For example, ML modeling engine 630 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 602a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 630 may include model selector engine 632 (e.g., configured to select a model from among a plurality of models, such as based on input data), parameter engine 634 (e.g., configured to add, remove, and/or change one or more parameters of a model), and/or model generation engine 636 (e.g., configured to generate one or more machine learning models, such as according to model input data, model output data, comparison data, and/or validation data).

In some aspects, model selector engine 632 may be configured to receive input and/or transmit output to ML algorithms database 670. Similarly, featurization engine 620 can utilize storage or system memory for storing data and can utilize one or more I/O devices or network interfaces for transmitting or receiving data. ML algorithms database 670 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 670 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 670 include versions DALL·E, CHAT GPT, and SORA, all provided by OPEN AI.

System 600 can further include predictive output generation engine 645 and output validation engine 650 (e.g., configured to apply validation data to machine learning model output). Predictive output generation engine 645 can analyze the input and identify relevant patterns and associations in the data it has learned to generate a sequence of words that predictive output generation engine 645 predicts is the most likely continuation of the input using one or more models from the ML algorithms database 670, aiming to provide a coherent and contextually relevant answer. Predictive output generation engine 645 generates responses by sampling from the probability distribution of possible words and sequences, guided by the patterns observed during its training. In some aspects, predictive output generation engine 645 can generate multiple possible responses before presenting the final one. Predictive output generation engine 645 can generate multiple responses based on the input, and these responses are variations that predictive output generation engine 645 considers potentially relevant and coherent. Output validation engine 650 can evaluate these generated responses based on certain criteria. These criteria can include relevance to the prompt, coherence, fluency, and sometimes adherence to specific guidelines or rules, depending on the application. Based on this evaluation, output validation engine 650 selects the most appropriate response. This selection is typically the one that scores highest on the set criteria, balancing factors like relevance, informativeness, and coherence.

System 600 can further include feedback engine 660 (e.g., configured to apply feedback from a user and/or machine to a model) and model refinement engine 655 (e.g., configured to update or re-configure a model). In some aspects, feedback engine 660 may receive input and/or transmit output (e.g., output from a trained, partially trained, or untrained model) to outcome metrics database 665. Outcome metrics database 665 may be configured to store output from one or more models and may also be configured to associate output with one or more models. In some aspects, outcome metrics database 665, or other device (e.g., model refinement engine 655 or feedback engine 660), may be configured to correlate output, detect trends in output data, and/or infer a change to input or model parameters to cause a particular model output or type of model output. In some aspects, model refinement engine 655 may receive output from predictive output generation engine 645 or output validation engine 650. In some aspects, model refinement engine 655 may transmit the received output to featurization engine 620 or ML modeling engine 630 in one or more iterative cycles.

The engines of system 600 may be packaged functional hardware units designed for use with other components or a part of a program that performs a particular function (e.g., of related functions). Any or each of these modules may be implemented using a computing device. In some aspects, the functionality of system 600 may be split across multiple computing devices to allow for distributed processing of the data, which may improve output speed and reduce computational load on individual devices. In some aspects, system 600 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 600 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

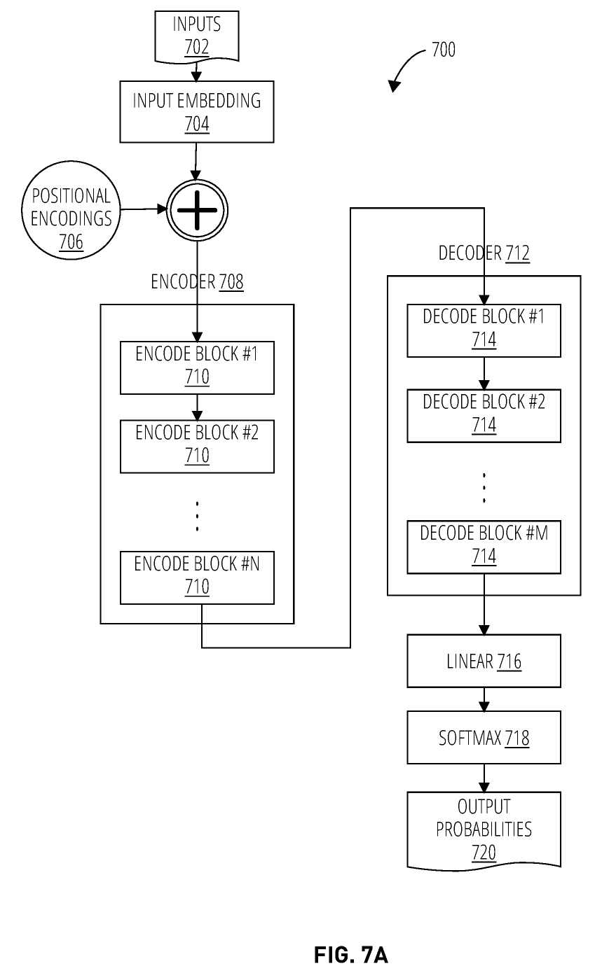

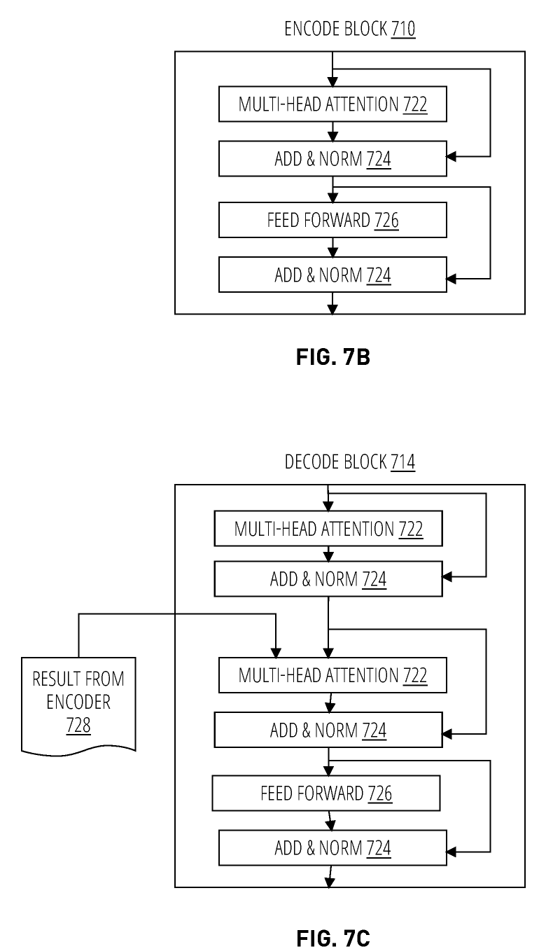

FIGS. 7A, 7B, and 7C, 7B illustrates an example transformer architecture in accordance with some aspects of the present technology. Examples of ML models that use a transformer neural network (e.g., transformer architecture 700) can include, e.g., generative pretrained transformer (GPT) models and Bidirectional Encoder Representations from Transformer (BERT) models. The transformer architecture 700, which is illustrated in FIGS. 7A, 7B, 7C , includes inputs 702, input embedding block 704, positional encodings 706, encoder 708 including encode blocks 710, decoder 712 including decode blocks 714, linear block 716, softmax block 718, and output probabilities 720.

Input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension that have the same dimension as the positional encodings, for example.

Positional encodings 706 provide information about the relative or absolute position of the tokens in the sequence. According to certain non-limiting examples, positional encodings 706 can be provided by adding positional encodings to the input embeddings at the inputs to the encoder 708 and decoder 712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 708 can use stacked self-attention and point-wise, fully connected layers. Encoder 708 can be a stack of N identical layers (e.g., N = 6), and each layer can be an encode block, as illustrated by encode block 710 shown in FIG. 7B. Each encode block 710 has two sub-layers: (i) a first sub-layer has a multi-head attention block 722 and (ii) a second sub-layer has a feed forward block 726, which can be a position-wise fully connected feed-forward network. The feed forward block 726 can use a rectified linear unit (ReLU).

Encoder 708 uses a residual connection around each of the two sub-layers, followed by an add & norm block 724, which performs normalization. For example, the output of each sub-layer can be LayerNorm(x+ Sublayer(x)). To facilitate these residual connections, all sub-layers in the model, as well as the embedding layers, produce output data having a same dimension.

Similar to encoder 708, decoder 712 uses stacked self-attention and point-wise, fully connected layers. Decoder 712 can also be a stack of M identical layers (e.g., M = 6), and each layer can be a decode block, as illustrated by decode block 712 shown in FIG. 7B. In addition to the two sub-layers (i.e., the sublayer with multi-head attention block 722 and the sub-layer with feed forward block 726) found in encode block 710, decode block 714 can include a third sub-layer, which performs multi-head attention over the output of the encoder stack. Similar to encoder 708, decoder 712 uses residual connections around each of the sub-layers, followed by layer normalization. Additionally, the sub-layer with multi-head attention block 722 can be modified in the decoder stack to prevent positions from attending to subsequent positions. This masking, combined with the fact that the output embeddings are offset by one position, can ensure that the predictions for position i can depend only on the known output data at positions less than i.

Linear block 716 can be a learned linear transformation. For example, when transformer architecture 700 is being used to translate from a first language into a second language, linear block 716 can project the output from the last decode softmax block 718 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 718 then turns the scores from linear block 716 into output probabilities 720 (which add up to 1.0). In each position, the index provides for the word with the highest probability, and then maps that index to the corresponding word in the vocabulary. Those words then form the output sequence of transformer architecture 700. The softmax operation is applied to the output from linear block 716 to convert the raw numbers into output probabilities 720 (e.g., token probabilities).

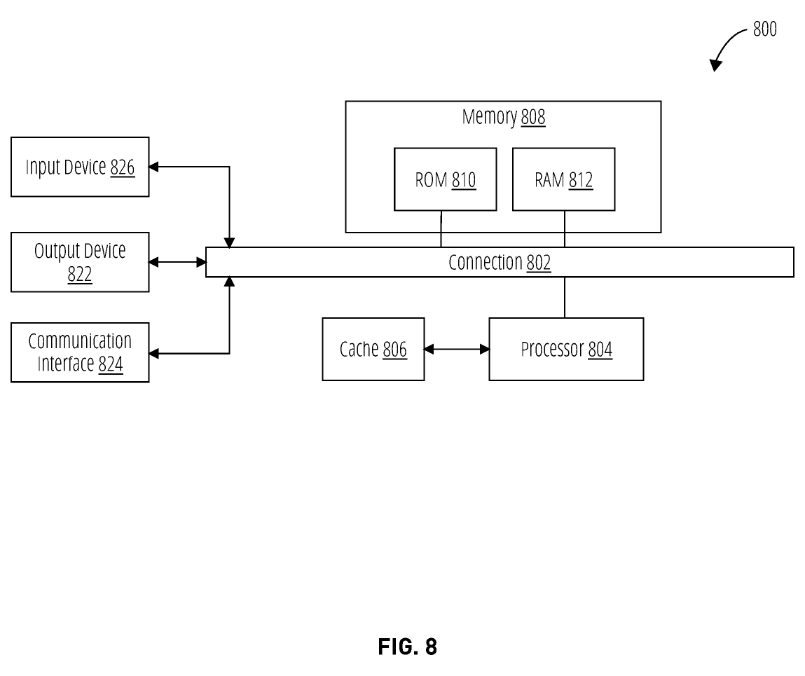

FIG. 8 shows an example of computing system 800, which can be, for example, any computing device making up any engine illustrated in FIG. 1 or any component thereof.

In some aspects, computing system 800 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 800 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 800 includes at least one processing unit (CPU or processor) 804 and connection 802 that couples various system components including system memory 808, such as read-only memory (ROM) 810 and random access memory (RAM) 812 to processor 804. Memory 808 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 808 can include software services, servers, logic, etc., that when the code that defines such software is executed by the processor 804, it causes the system to perform a function. In some aspects, a hardware service that performs a particular function can include the software component stored in a computer-readable medium in connection with the necessary hardware components, such as processor 804, connection 802, output device 822, etc., to carry out the function.

Computing system 800 can include a cache of high-speed memory 806 connected directly with, in close proximity to, or integrated as part of processor 804.

Connection 802 can be a physical connection via a bus, or a direct connection into processor 804, such as in a chipset architecture. Connection 802 can also be a virtual connection, networked connection, or logical connection.

Processor 804 can include any general purpose processor and a hardware service or software service stored in memory 808, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric. Processor 804 can be physcial or virtual.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

In some aspects, computing system 800 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

Aspect 1: A method comprising: receiving, at a safety engine, a stream of tokens, wherein the stream of tokens is output by a generative response engine and wherein respective tokens in the stream of tokens are assigned an index; processing, by the safety engine, a respective token from the stream of tokens using a safety plugin; and outputting, to a front end of the generative response engine, tokens from the token stream while a difference between an index of a respective output token and an index of the respective token processed by the safety plugin is less than a buffer.

Aspect 2: The method of Aspect 1, further comprising: feeding a safety queue with the stream of tokens from a main queue, wherein the safety queue feeds the stream of tokens to the safety engine and wherein the main queue comprising the stream of tokens; and feeding an output queue with a duplicate stream of the stream of tokens from the main queue, wherein the output queue feeds the duplicate stream of tokens to the front end.

Aspect 3: The method of any of Aspects 1-2, wherein processing the respective token using the safety plugin comprises determining, based on output of the safety plugin, that the respective token can be output to the user account.

Aspect 4: The method of any of Aspects 1-3, wherein processing the respective token using the safety plugin comprises determining, based on output of the safety plugin, that the respective token cannot be output to the user account.

Aspect 5: The method of any of Aspects 1-4, further comprising: based on the output of the safety plugin, inserting, by the safety engine into the output queue, a stop token, wherein the stop token causes the output queue to stop outputting tokens to the front end, end wherein the stop token includes metadata configured to cause the front end to output a message to the user account.

Aspect 6: The method of any of Aspects 1-5, further comprising: based on the output of the safety plugin, providing, by the safety engine, a message to the generative response engine, wherein the message causes the generative response engine to cease output of the stream of tokens.

Aspect 7: The method of any of Aspects 1-6, further comprising: determining, by the safety engine, that the difference between the index of the respective output token and the index of the respective token processed by the safety plugin is greater than or equal to the buffer; and causing, by the safety engine, the front end to pause output of the stream of tokens until a difference between the index of the respective output token and an index of a token being processed by the safety plugin is less than the buffer.

Aspect 8: A non-transitory computer-readable medium having stored thereon instructions that, when executed by at least one processor, cause the at least one processor to perform operations according to any of Aspects 1 to 7.

Aspect 9: A computing system for performing a function, comprising one or more means for performing operations according to any of Aspects 1 to 7.

The present technology includes computer-readable storage mediums for storing instructions, and systems for executing any one of the methods embodied in the instructions addressed in the aspects of the present technology presented below:

What is claimed is:

1. A method comprising:
receiving, at a safety engine, a stream of tokens, wherein the stream of tokens is output by a generative response engine and wherein respective tokens in the stream of tokens are assigned an index;
processing, by the safety engine, a respective token from the stream of tokens using a safety plugin; and
outputting, to a front end of the generative response engine, tokens from the token stream while a difference between an index of a respective output token and an index of the respective token processed by the safety plugin is less than a buffer.

2. The method of claim 1, further comprising:
feeding a safety queue with the stream of tokens from a main queue, wherein the safety queue feeds the stream of tokens to the safety engine and wherein the main queue comprising the stream of tokens; and
feeding an output queue with a duplicate stream of the stream of tokens from the main queue, wherein the output queue feeds the duplicate stream of tokens to the front end.

3. The method of claim 1, wherein processing the respective token using the safety plugin comprises determining, based on output of the safety plugin, that the respective token can be output to the user account.

4. The method of claim 1, wherein processing the respective token using the safety plugin comprises determining, based on output of the safety plugin, that the respective token cannot be output to the user account.

5. The method of claim 4, further comprising:
based on the output of the safety plugin, inserting, by the safety engine into the output queue, a stop token, wherein the stop token causes the output queue to stop outputting tokens to the front end, end wherein the stop token includes metadata configured to cause the front end to output a message to the user account.

6. The method of claim 4, further comprising:
based on the output of the safety plugin, providing, by the safety engine, a message to the generative response engine, wherein the message causes the generative response engine to cease output of the stream of tokens.

7. The method of claim 1, further comprising:
determining, by the safety engine, that the difference between the index of the respective output token and the index of the respective token processed by the safety plugin is greater than or equal to the buffer; and
causing, by the safety engine, the front end to pause output of the stream of tokens until a difference between the index of the respective output token and an index of a token being processed by the safety plugin is less than the buffer.

8. A computing system comprising:
at least one processor; and
a memory storing instructions that, when executed by the at least one processor, configure the computing system to:
receive a stream of tokens, wherein the stream of tokens is output by a generative response engine and wherein respective tokens in the stream of tokens are assigned an index;
process a respective token from the stream of tokens using a safety plugin; and
output, to a front end of the generative response engine, tokens from the token stream while a difference between an index of a respective output token and an index of the respective token processed by the safety plugin is less than a buffer.

9. The computing system of claim 8, wherein the instructions further configure the computing system to:
feed a safety queue with the stream of tokens from a main queue, wherein the safety queue feeds the stream of tokens to the safety engine and wherein the main queue comprising the stream of tokens; and
feed an output queue with a duplicate stream of the stream of tokens from the main queue, wherein the output queue feeds the duplicate stream of tokens to the front end.

10. The computing system of claim 8, wherein processing the respective token using the safety plugin comprises determining, based on output of the safety plugin, that the respective token can be output to the user account.

11. The computing system of claim 8, wherein processing the respective token using the safety plugin comprises determining, based on output of the safety plugin, that the respective token cannot be output to the user account.

12. The computing system of claim 11, wherein the instructions further configure the computing system to:
based on the respective token not being safe for output to the user account, insert, into the output queue, a stop token, wherein the stop token causes the front end to cease providing further output to the user account.

13. The computing system of claim 11, wherein the instructions further configure the computing system to:
based on the output of the safety plugin, provide a message to the generative response engine, wherein the message causes the generative response engine to cease output of the stream of tokens.

14. The computing system of claim 8, wherein the instructions further configure the computing system to:
determine that the difference between the index of the respective output token and the index of the respective token processed by the safety plugin is greater than or equal to the buffer; and
cause the front end to pause output of the stream of tokens until a difference between the index of the respective output token and an index of a token being processed by the safety plugin is less than the buffer.

15. A non-transitory computer-readable medium comprising instructions that when executed by at least one processor, cause the at least one processor to:
receive a stream of tokens, wherein the stream of tokens is output by a generative response engine and wherein respective tokens in the stream of tokens are assigned an index;
process a respective token from the stream of tokens using a safety plugin; and
output, to a front end of the generative response engine, tokens from the token stream while a difference between an index of a respective output token and an index of the respective token processed by the safety plugin is less than a buffer.

16. The non-transitory computer-readable medium of claim 15, wherein the instructions further configure the at least one processor to:
feed a safety queue with the stream of tokens from a main queue, wherein the safety queue feeds the stream of tokens to the safety engine and wherein the main queue comprising the stream of tokens; and
feed an output queue with a duplicate stream of the stream of tokens from the main queue, wherein the output queue feeds the duplicate stream of tokens to the front end.

17. The non-transitory computer-readable medium of claim 15, wherein processing the respective token using the safety plugin comprises determining, based on output of the safety plugin, that the respective token can be output to the user account.

18. The non-transitory computer-readable medium of claim 15, wherein processing the respective token using the safety plugin comprises determining, based on output of the safety plugin, that the respective token cannot be output to the user account.

19. The non-transitory computer-readable medium of claim 18, wherein the instructions further configure the at least one processor to:
based on the respective token not being safe for output to the user account, insert, into the output queue, a stop token, wherein the stop token causes the front end to cease providing further output to the user account.

20. The non-transitory computer-readable medium of claim 18, wherein the instructions further configure the at least one processor to:
based on the output of the safety plugin, provide a message to the generative response engine, wherein the message causes the generative response engine to cease output of the stream of tokens.
